(19) United States
(12) Patent Application Publication
(10) Pub. No.: US 2026/0358925 A1
(43) Pub. Date: Nov. 12, 2026

(54) CURSOR CONTROL SYSTEM BASED ON MONOCHROME STICK IMAGE RECOGNITION

(71) Applicant: Bihong Chen, Shenzhen City (CN)

(72) Inventor: Bihong Chen, Shenzhen City (CN)

(21) Appl. No.: 19/389,831

(22) Filed: Nov. 14, 2025

(30) Foreign Application Priority Data
May 6, 2025 (CN) 202510575621.0

(51) Int. Cl. G06F 3/042; G06T 7/13

(52) U.S. Cl. CPC G06F 3/0425; G06T 7/13

(57) ABSTRACT

A cursor control system based on monochrome stick image recognition, an image acquisition module, used for acquiring continuous video frames containing a monochrome stick-shaped object in real time; a preprocessing module, which converts the video frames from the RGB color space to the HSV color space and establishes a monochrome hue threshold range model; a target detection module, which performs noise reduction on the binary image, adopts Canny edge detection combined with contour analysis algorithm to extract monochrome stick-shaped objects that meet the following geometric features; a coordinate mapping module, which converts the detected geometric center coordinates of the monochrome stick into the screen cursor coordinates; an action recognition module, which determines the operation instruction; a control module: it maps the geometric center position of the monochrome stick to the screen coordinate system, and responds to the click signal to perform the click operation.

### TECHNICAL FIELD

The invention relates to the technical field of human-computer interaction, and in particular to a cursor control system based on monochrome stick image recognition.

### BACKGROUND ART

With the advancement of technology, the way of human-computer interaction has been constantly innovated, from traditional keyboards and mice to touch screens, and then to interaction methods based on gesture recognition, the user experience has been significantly improved.

The existing cursor control technologies mainly include the following:
traditional input devices: such as mice, touchpads, and keyboards, which provide high control precision and response speed in desktop environments; however, in applications such as large-screen displays and smart TVs, the user experience with traditional input devices is poor; users need to frequently move their arms or stand up to operate, leading to fatigue and inconvenience;
touchscreen technology: touchscreen technology is widely used in devices like smartphones and tablets, allowing users to interact directly by touching the screen; this provides an intuitive method of interaction; however, on large-screen devices, the use of touchscreens is limited; users must be close to the screen to operate, and there are conflicts when multiple people share the screen;
camera-based 2D gesture recognition technology: this technology uses cameras to capture the user's hand gestures, enabling non-contact control; devices like Kinect and Leap Motion utilize depth sensors and computer vision algorithms to recognize the user's gestures and convert them into control commands; however, these technologies have low recognition accuracy in complex lighting environments and have limitations in gesture range and precision; moreover, existing technologies often rely on complex machine learning algorithms, and real-time performance and stability need improvement;
infrared sensor-based control technology: some smart TVs and game consoles use infrared sensors to capture user movements and enable simple control functions; however, the recognition accuracy and response speed of these technologies are limited, making it difficult to achieve precise cursor control, and they are easily affected by environmental light.

Despite the progress made in human-computer interaction with existing technologies, the following technical issues still exist in practical applications:
insufficient control precision: traditional input devices and touchscreens fail to provide sufficient control precision in certain application scenarios, especially in large-screen displays and long-distance operations, leading to a poor user experience;
poor environmental adaptability: camera-based 2D gesture recognition technology and infrared sensor-based control technology have low recognition accuracy in complex lighting environments and are easily affected by ambient light, resulting in unstable control; additionally, the recognition range and precision of user gestures are limited;
insufficient real-time performance and stability: existing technologies often rely on complex machine learning algorithms, and their real-time performance and stability need improvement; during fast movements or continuous operations, recognition speed and response time may lag behind, affecting the user experience.

Therefore, a cursor control system based on monochrome stick image recognition is proposed to address the existing shortcomings.

### SUMMARY OF THE INVENTION

The technical problems to be solved by the invention is to overcome the defects of the technologies mentioned hereinabove and provide a cursor control system based on monochrome stick image recognition.

To address the technical problems mentioned hereinabove, the technical solution provided by the invention is a cursor control system based on monochrome stick image recognition, comprising:
an image acquisition module, used for acquiring continuous video frames containing a monochrome stick-shaped object in real time through a camera;
a preprocessing module, which converts the video frames from the RGB color space to the HSV color space and establishes a monochrome hue threshold range model:

Hₘᵢₙ∈[35,77] Sₘᵢₙ≥50 Vₘᵢₙ≥50
wherein: H refers to the hue value, S refers to the saturation, V refers to the lightness value;
a target detection module, which performs noise reduction on the binary image through morphological operations, adopts Canny edge detection combined with contour analysis algorithm to extract monochrome stick-shaped object that meet the following geometric features:

length-width ratio≥3:1 outline area≥100 pixels circularity≤0.3
a coordinate mapping module, which converts the detected geometric center coordinates (x_{c},y_{c}) of the monochrome stick-shaped object into the screen cursor coordinates (X,Y) through a bilinear interpolation algorithm:

$$X = \frac{{x}_{c} - {x}_{m i n}}{{x}_{m ax} - {x}_{m i n}} \times {W}_{screen}$$

$$Y = \frac{{y}_{m ax} - {y}_{c}}{{y}_{m ax} - {y}_{m i n}} \times {H}_{screen}$$

wherein, (xₘᵢₙ, yₘᵢₙ) and (xₘₐₓ, yₘₐₓ) refer to the boundary coordinates of the image acquisition area, W_{screen} and H_{screen} refer to the screen display resolutions;
an action recognition module, which determines the operation instruction by calculating the displacement vector modulus |Δ\vec{r}| and angular velocity ω of the monochrome stick-shaped object between consecutive frames:

$$\vert Δ \vec{r} \vert = \sqrt{{( {x}_{c , t} - {x}_{c , t - 1} )}^{2} + {( {y}_{c , t} - {y}_{c , t - 1} )}^{2}}$$

$$ω = arctan ( \frac{{y}_{c , t} - {y}_{c , t - 1}}{{x}_{c , t} - {x}_{c , t - 1}} )$$

when |Δ\vec{r}|>15 pixels and the @ mutation exceeds 45 degree, a click event is triggered;
a control module: it maps the geometric center position of the monochrome stick-shaped object to the screen coordinate system, and responds to the click signal to perform the click operation.

As an improvement, the preprocessing module comprises an adaptive illumination compensation unit, which dynamically adjusts the V channel through a histogram equalization algorithm; the compensation coefficient is calculated as follows:

$${k}_{comp} = \frac{{V}_{target}}{{V}_{ang}} ( {V}_{avg} \geq 128 )$$

wherein, V_{target} refers to the target brightness value, taking the range of 180-220.

As an improvement, the coordinate mapping module integrates a three-dimensional space compensation algorithm; when the camera and the display screen are in a non-orthogonal layout, a perspective transformation matrix is introduced:

$$[ \begin{matrix}X \\ Y \\ 1\end{matrix} ] = [ \begin{matrix}{a}_{11} & {a}_{12} & {a}_{13} \\ {a}_{21} & {a}_{22} & {a}_{23} \\ {a}_{31} & {a}_{32} & 1\end{matrix} ] [ \begin{matrix}{x}_{c} \\ {y}_{c} \\ 1\end{matrix} ]$$

wherein, the matrix parameters are obtained in advance through Zhang Zhengyou calibration method.

As an improvement, it also comprises an anti-occlusion unit, when the monochrome stick-shaped object is temporarily occluded, the cursor position continuity is maintained based on a motion prediction model, and the prediction formula is:

[symbol]

(t+1)=x_{c}(t)+vₓ(t)·Δt, [symbol] (t+1)=y_{c}(t)+v_{y}(t)·Δt
wherein, vₓ, v_{y} refer to the instantaneous velocity of the geometric center of the monochrome stick before occlusion.

As an improvement, the motion recognition module comprises a multi-user interaction unit; when multiple monochrome stick-shaped objects are detected, the control rights are allocated according to the following priority rules:
the target with the largest area has the highest priority;
the target that has just entered the field of view has temporary priority (lasts for 3 seconds);
the target with overlapping areas exceeding 50% activate competition mode, and those with faster displacement speeds gain control.

As an improvement, it also comprises an environment adaptation module, which continuously optimizes the detection parameters through a machine learning algorithm, wherein the algorithm adopts an improved YOLOv5 network structure, and the loss function is defined as:

L=λ_{cls}L_{cls}+λ_{obj}L_{obj}+λ_{box}L_{box}
wherein, λ_{cls}=0.5, λ_{obj}=1.0, λ_{box}=1.5.

As an improvement, the camera is a wide-angle lens with a field of view angle θ>120° and a frame rate f≥30 fps, which is suitable for cursor control in large space scenes.

As an improvement, a reflective mark or an infrared transmitter may be attached to an end of the monochrome stick-shaped object, which can be used in conjunction with a camera to achieve multi-modal positioning, thereby improving recognition robustness in complex lighting environments.

As an improvement, the control module supports protocol compatibility with external devices, thereby achieving cross-platform control of televisions, computers or smart terminals.

As an improvement, the protocols of the external device comprises HDMI-CEC, USB HID and Bluetooth interface.

The advantages of the invention compared with the prior art are:
1. the invention realizes high-precision control of the cursor through precise geometric feature extraction and coordinate mapping algorithms; by adopting the Canny edge detection and contour analysis algorithm, the geometric center of the monochrome stick-shaped object can be accurately identified and mapped to the screen coordinate system, thereby achieving precise cursor positioning;
2. the invention, through HSV color space conversion and an adaptive illumination compensation unit, can dynamically adjust the brightness value of the image to compensate for the influence of illumination changes; in addition, the improved YOLOv5 network structure further enhances recognition robustness under complex backgrounds and different lighting conditions, ensuring that the system can operate stably in various environments;
3. the invention, through an online learning and dynamic weight adjustment mechanism, can continuously optimize detection parameters based on real-time detection data, thereby improving the real-time response capability of the system; at the same time, when the monochrome stick-shaped object is temporarily occluded, the motion prediction model can predict its position based on historical velocity, maintaining the continuity of the cursor position and thus improving the overall stability of the system;
4. the invention can effectively distinguish the handheld monochrome sticks of different users through multi-user interaction units and priority rules, and allocate control rights according to parameters such as area, order of entering the field of view, and displacement speed, ensuring stable control in a multi-user environment;
5. the invention, through an anti-occlusion unit, based on the motion prediction model, can predict the position of the monochrome stick-shaped object in the next frame when it is occluded, thereby maintaining the continuity of the cursor position and enhancing the user's control experience;
6. the invention, through an environment adaptive module that continuously optimizes detection parameters using machine learning algorithms, can automatically adjust system parameters according to different environmental conditions, thereby improving the adaptability and detection accuracy of the system in different environments;
7. the invention is based on a solid color stick; through the operation of the solid color stick, efficient, accurate and user-friendly cursor control is achieved, which significantly improves the human-computer interaction experience.

### BRIEF DESCRIPTION OF ACCOMPANY DRAWINGS

FIG. 1 is a schematic diagram of the cursor control system based on monochrome stick image recognition according to the invention.

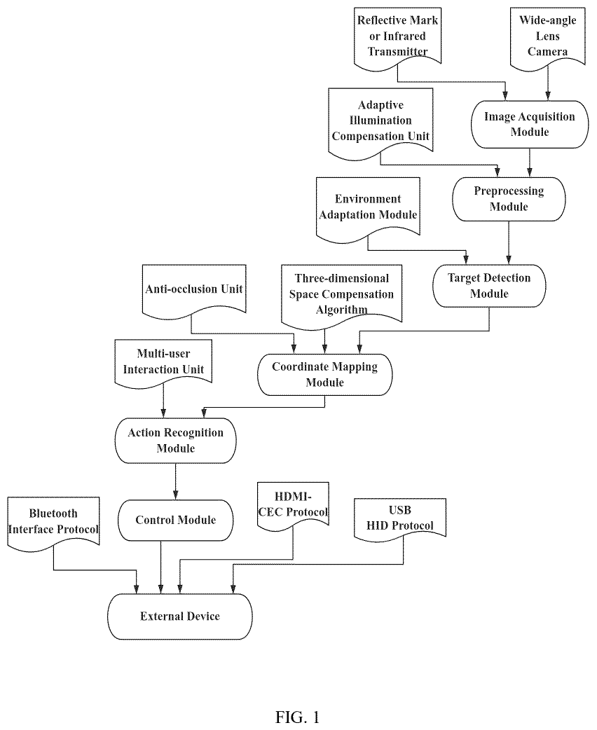

FIG. 2 is a schematic diagram of the cursor control system based on monochrome stick image recognition according to the invention.

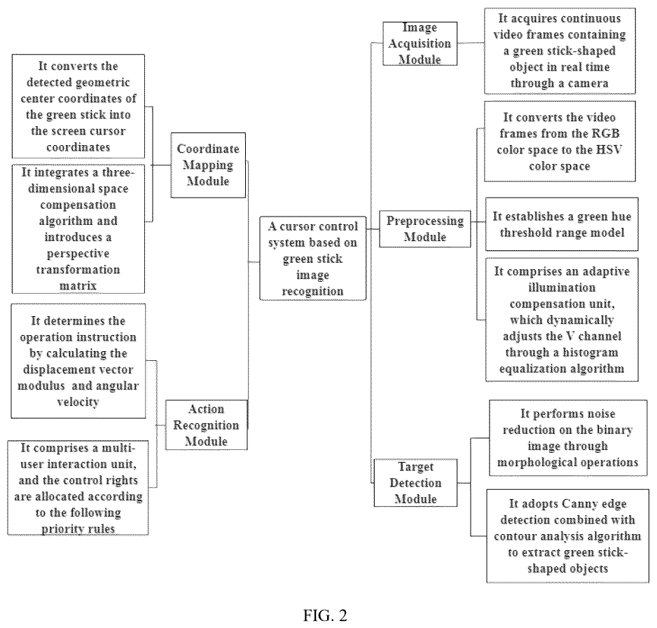

### SPECIFIC EMBODIMENT OF THE INVENTION

In order to make the objectives, technical solutions, and advantages of the embodiments of the invention clearer, the technical solutions in the embodiments of the invention will be described clearly and completely hereinafter with reference to the drawings in the embodiments of the invention. Obviously, the described embodiments are part of the embodiments of the invention, rather than all of the embodiments. The components of the embodiments of the invention generally described and illustrated in the drawings herein may be arranged and designed in various different configurations.

In the description of the embodiments of the invention, it also needs to be explained that unless otherwise explicitly stipulated or limited, the orientation or positional relationship indicated by the terms “center”, “upper”, “lower”, “left”, “right”, “vertical”, “horizontal”, “inner”, “outer” are based on the orientation or position relationship shown in the accompanying drawings, or the customary orientation or positional relationship when the product of the invention is in use, which is intended only to facilitate the description of the invention and simplify the description, rather than indicating or implying that the indicated device or element must have a specific orientation, be constructed and operated in a particular orientation. Therefore, it cannot be understood as limiting the invention. In addition, the terms “first”, “second”, “third” are only used to distinguish the description and should not be understood as indicating or implying relative importance.

In addition, the terms “horizontal”, “vertical” and “suspended” do not mean that the components are absolutely horizontal or suspended but may be slightly inclined. For example, “horizontal” only means that its direction is more horizontal relative to “vertical” and does not mean that the structure must be completely horizontal but may be slightly inclined.

In the description of the invention, “multiple” means two or more.

In the invention, it also should explain that unless otherwise clearly defined and limited, the terms “provided”, “installed”, “connected” and other terms should be interpreted broadly; for example, it can be a fixed connection, it can be a detachable connection, or integrated; it can be a mechanical connection or an electrical connection; it can be a direct connection, or an indirectly connection through an intermediate medium, and it can be an internal communication between two elements or the interaction relationship between two elements. For those of ordinary skill in the art, the specific meaning of the above terms in the invention can be understood according to specific circumstances.

In combination with the drawings, a cursor control system based on monochrome stick image recognition, comprising:
an image acquisition module, used for acquiring continuous video frames containing a monochrome stick-shaped object in real time through a camera, providing necessary input data for subsequent processing modules.

Specifically, the camera is a wide-angle lens is suitable for cursor control in large space scenes; in this embodiment, the field of view angle θ≥120°, covering the motion range of the monochrome stick in large space scenes; the frame rate f≥30 fps, ensuring the capture of smooth motion trajectory and avoiding ghosting or delay.

During implementation, a reflective mark or an infrared transmitter may be attached to an end of the monochrome stick-shaped object, which can be used in conjunction with a camera to achieve multi-modal positioning, thereby improving recognition robustness in complex lighting environments.

A preprocessing module, which converts the video frames from the RGB color space to the HSV color space and establishes a monochrome hue threshold range model:

Hₘᵢₙ∈[35,77] Sₘᵢₙ≥50 Vₘᵢₙ≥50
wherein: H refers to the hue value, S refers to the saturation, V refers to the lightness value.

During implementation, when a pixel has an RGB value of (30, 200, 80), the HSV value is (50, 85, 90) after conversion, which meets the threshold condition and is retained as a candidate region.

Further, the preprocessing module comprises an adaptive illumination compensation unit, which dynamically adjusts the V channel through a histogram equalization algorithm; the compensation coefficient is calculated as follows:

$${k}_{comp} = \frac{{V}_{target}}{{V}_{ang}} ( {V}_{avg} \geq 128 )$$

wherein, V_{target} refers to the target brightness value, taking the range of 180-220.

During implementation:
(1) target brightness value: V_{target}=200 (taking the middle value);
(2) average brightness calculation:
assuming the average brightness of the current frame V_{ang}=150, meeting V_{ang}≥128;
(3) compensation coefficient calculation

$${k}_{comp} = \frac{{V}_{target}}{{V}_{ang}} = \frac{200}{150} \approx 1.333$$

(4) V-channel adjustment:
for each pixel, the new brightness value V_{new}=V_{old}×k_{comp};
example pixel after adjustment:

V_{new}=V_{old}×k_{comp}=100×1.333≈133(meeting Vₘᵢₙ>50)

Therefore, by increasing the brightness of low-light regions (for example, raising V from 100 to 133), the contrast between the monochrome stick and the background is enhanced.

During specific implementation,
HSV threshold segmentation:
4.1 specific calculation formula

$$Mask ( x , y ) = \{ \begin{matrix}1 & if \begin{matrix}H ∈ [ 35 , 77 ] & S \geq 50 & V \geq 50\end{matrix} \\ 0 & ootherwise\end{matrix}$$

4.2 example data:
the original HSV value of a pixel is (50, 85, 90);
after dynamic illumination compensation, the HSV value is (H=50, S=85, V=120); judgment:

H=50∈[35,77], S=85≥50, V=120≥50⇒1
that is, pixels meeting the monochrome characteristics (such as monochrome stick-shaped objects) are selected, while other color interferences (such as red or blue objects) are excluded;
a target detection module, which performs noise reduction on the binary image through morphological operations, adopts Canny edge detection combined with contour analysis algorithm to extract monochrome stick-shaped object that meet the following geometric features:

length-width ratio≥3:1 outline area≥100 pixels circularity≤0.3
During specific implementation:
candidate contour filtering:
length-width ratio:

$$length - width ratio = \frac{contour width}{contour height} \geq 3 : 1$$

example: if the contour width is 150 pixels and the height is 50 pixels→length-width ratio=3:1, which meets the requirement;
contour area:

area=number of pixels≥100
example: if the contour contains 200 pixels→it meets the requirement;
(3) circularity:

$$circularity = \frac{4 π \times area}{{perimeter}^{2}} \leq 0.3$$

example: if the perimeter is 100 pixels and the area is 200 pixels→circularity≈0.628 (it does not meet the requirement and is eliminated);
a coordinate mapping module, which converts the detected geometric center coordinates (x_{c}, y_{c}) of the monochrome stick-shaped object into the screen cursor coordinates (X, Y) through a bilinear interpolation algorithm:

$$X = \frac{{x}_{c} - {x}_{m i n}}{{x}_{m ax} - {x}_{m i n}} \times {W}_{screen}$$

$$Y = \frac{{y}_{ma x} - {y}_{c}}{{y}_{m ax} - {y}_{m i n}} \times {H}_{screen}$$

wherein, (xₘᵢₙ, yₘᵢₙ) and (xₘₐₓ, yₘₐₓ) refer to the boundary coordinates of the image acquisition area, W_{screen} and H_{screen} refer to the screen display resolutions.

Further, the coordinate mapping module integrates a three-dimensional space compensation algorithm; when the camera and the display screen are in a non-orthogonal layout, a perspective transformation matrix is introduced:

$$[ \begin{matrix}X \\ Y \\ 1\end{matrix} ] = [ \begin{matrix}{a}_{11} & {a}_{12} & {a}_{13} \\ {a}_{21} & {a}_{22} & {a}_{23} \\ {a}_{31} & {a}_{32} & 1\end{matrix} ] [ \begin{matrix}{x}_{c} \\ {y}_{c} \\ 1\end{matrix} ]$$

wherein, the matrix parameters are obtained in advance through Zhang Zhengyou calibration method.

During specific implementation:
1. input data
1.1 geometric center coordinates of the monochrome stick-shaped object:
the center coordinate of the monochrome stick-shaped object obtained through the target detection module is (x_{c}, y_{c})=(960, 500) (pixels, based on the image acquisition region);
image acquisition region boundary:
the top-left corner coordinates: (xₘᵢₙ, yₘᵢₙ)=(100, 50);
the bottom-right corner coordinates: (xₘₐₓ, yₘₐₓ)=(1820, 930);
2. screen resolution:
width: W_{screen}=1920 pixels;
height: H_{screen}=1080 pixels;
3. perspective transformation matrix (calibrated by Zhang Zhengyou calibration method);

$$T = [ \begin{matrix}0.98 & - 0.12 & 10 \\ 0.05 & 0.99 & 5 \\ 0. & 0. & 1\end{matrix} ]$$

5. coordinate mapping calculation:
5.1 horizontal (X-axis) mapping

$$X = \frac{{x}_{c} - {x}_{m i n}}{{x}_{m ax} - {x}_{m i n}} \times {W}_{screen} = \frac{960 - 100}{1820 - 100} \times 1920 \approx 960 pixels$$

that is, when the monochrome stick-shaped object is located at the center of the image, it remains at the center of the screen after mapping;
5.2 vertical (Y-axis) mapping

$$Y = \frac{{y}_{m ax} - {y}_{c}}{{y}_{ma x} - {y}_{m i n}} \times {H}_{screen} = \frac{1080 - 500}{1080 - 50} \times 1080 \approx 607 pixels$$

5.3 mapping result:
the screen coordinate (X, Y) is =(960,607); at this time, the monochrome stick-shaped object is located slightly above the center of the screen;
during the implementation, when the camera and the screen are provided in a non-orthogonal layout (for example, the camera overlooks while the screen is placed horizontally), perspective distortion needs to be corrected;

$$[ \begin{matrix}X \\ Y \\ 1\end{matrix} ] = T \cdot [ \begin{matrix}{x}_{c} \\ {y}_{c} \\ 1\end{matrix} ]$$

specifically:
substitute the image coordinates (x_{c}, y_{c}, 1) into the matrix:

$$[ \begin{matrix}X \\ Y \\ 1\end{matrix} ] = [ \begin{matrix}0.98 \times 960 - 0.12 \times 500 + 10 \\ 0.05 \times 960 + 0.99 \times 500 + 5 \\ 1\end{matrix} ]$$

that is:

X=900.8

Y=548
final screen coordinate:
(X, Y)=(901, 548), which corrects the coordinate offset caused by the camera's downward view;
the system also comprises an anti-occlusion unit; when the monochrome stick-shaped object is temporarily occluded, the cursor position continuity is maintained based on a motion prediction model, and the prediction formula is:

[symbol]

(t+1)=x_{c}(t)+vₓ(t)·Δt, [symbol] (t+1)=y_{c}(t)+v_{y}(t)·Δt
wherein, vₓ, v_{y} refer to the instantaneous velocity of the geometric center of the monochrome stick before occlusion.

During specific implementation, when the monochrome stick-shaped object is temporarily occluded, the next-frame position is predicted based on historical velocity:
1. the last-frame coordinates of the monochrome stick-shaped object before occlusion: (x_{c}, y_{c})=(960, 500);
2. velocity of the monochrome stick-shaped object before occlusion:
vₓ=3 pixels/frame (horizontal, rightward);
v_{y}=−2 pixels/frame (vertical, downward);
3. time interval: Δt=1 frame;
4. predicted coordinates for the next frame:

4.1 horizontal prediction

[symbol]

(t+1)=x_{c}(t)+vₓ(t)·Δt=960+3×1=963
4.2 vertical prediction;

[symbol]

(t+1)=y_{c}(t)+v_{y}(t)·Δt=500+(−2)×1=498
predicted next-frame coordinates: x\hat{ }c=960+3× 1=963; y\hat{ }c=500-2× 1=498.

5. predicted cursor position during occlusion
5.1 image coordinates ( [symbol] , [symbol] )=(963, 498);
5.2 screen coordinates (converted through the coordinate mapping module);

X=1084 pixels

Y=523 pixels
6. prediction result visualization:
6.1 before occlusion: the monochrome stick-shaped object is located at the center of the screen (X=960, Y=607);
6.2 during occlusion: the cursor position is predicted based on historical velocity as X=1084, Y=523 (located in the upper right area of the screen);
6.3 after visibility recovery: if the monochrome stick-shaped object reappears, the system immediately switches back to the actual detected coordinates; if not recovered, the prediction continues until the occlusion timeout (for example, 3 seconds).

An action recognition module, which determines the operation instruction by calculating the displacement vector modulus |Δ\vec{r}| and angular velocity ω of the monochrome stick object between consecutive frames:

$$\vert Δ \vec{r} \vert = \sqrt{{( {x}_{c , t} - {x}_{c , t - 1} )}^{2} + {( {y}_{c , t} - {y}_{c , t - 1} )}^{2}}$$

$$ω = arctan ( \frac{{y}_{c , t} - {y}_{c , t - 1}}{{x}_{c , t} - {x}_{c , t - 1}} )$$

when |Δ\vec{r}|>15 pixels and the w mutation exceeds 45 degree, a click event is triggered;

During specific implementation,
1. input data:
the geometric center coordinates of the monochromatic rod-shaped object in consecutive frames:
frame t: (x_{c, t}, y_{c, t})=(960, 500);
frame t−1: (x_{c, c, t-1}, y_{c, t-1})=(945, 505);
2. displacement vector magnitude calculation:

[Δ\vec{r}]=\sqrt{(x_{c,t}−x_{c,t-1})²+(y_{c,t}−y_{c,t-1})²}=\sqrt{(960−945)²+(500−505)²}≈15.81 pixels
the displacement magnitude is 15.81 pixels >15 pixels, meeting the displacement threshold for a click event;
3. angular velocity calculation:

$$ω = arctan ( \frac{{y}_{c , t} - {y}_{c , t - 1}}{{x}_{c , t} - {x}_{c , t - 1}} ) = arctan ( \frac{500 - 505}{960 - 945} ) \approx - 18.43 °$$

the angular velocity is −18.43°, indicating that the monochromatic rod-shaped object moves toward the lower-right direction with a gentle directional change;
4. result analysis:
angular velocity change amplitude

|ω−prev_{ω}|=|−18.43°−0°|=18.43°<45°
although the displacement magnitude of 15.81 pixels exceeds the threshold of 15 pixels, the angular velocity change amplitude does not meet the trigger condition for a click event;
further, the action recognition module comprises a multi-user interaction unit; when multiple monochromatic rod-shaped objects are detected, the control right is allocated according to the following priority rules:
the target with the largest area has the highest priority;
a newly entered target in the field of view obtains temporary priority for 3 seconds;
when the overlap area between two targets exceeds 50%, a competition mode is activated, and the target with the higher displacement speed obtains the control right.

During the implementation, when two monochrome stick-shaped objects (A and B) are detected simultaneously, the parameters are as follows:
monochrome stick-shaped object A:
area: 300 pixels;
displacement magnitude: 20 pixels;
angular velocity: 30°;
monochrome stick-shaped object B:
area: 150 pixels;
displacement magnitude: 10 pixels;
angular velocity: 5°;
priority determination:
based on area priority, monochrome stick-shaped object A has a larger area (300>150) and therefore obtains the highest control priority;
temporary priority for new targets: if monochrome stick-shaped object B is newly entering the field of view and the duration is less than 3 seconds, its priority is temporarily elevated;
competition mode: if the overlap area between the two exceeds 50%, their movement speeds are compared;
final control right: monochrome stick-shaped object A triggers the click event;
the system further also comprises an environment adaptation module, which continuously optimizes the detection parameters through a machine learning algorithm, wherein the algorithm adopts an improved YOLOv5 network structure, and the loss function is defined as:

L=λ_{cls}L_{cls}+λ_{obj}L_{obj}+λ_{box}L_{box}
wherein, λ_{cls}=0.5, λ_{obj}=1.0, λ_{box}=1.5.
During the implementation,
1. input data
1.1 training dataset:
the dataset contains 5000 labeled images, covering the following scenarios;
lighting conditions: 500-2000 lux (simulating indoor/outdoor light variations);
background complexity: plain backgrounds, textured backgrounds (e.g., wood grain, fabric), and dynamic backgrounds (e.g., moving people);
target states: complete monochromatic rod or partially occluded (e.g., occlusion by fingers);
1.2 real-time detection data:
continuous video frames captured by the camera (1920×1080 resolution, 30 fps), containing the motion of the monochromatic rod and environmental variations;
2. loss calculation:
assuming that, in a given training batch:
classification lossL_{cls}=0.3;
objectness loss L_{obj}=0.5;
bounding box loss L_{box}=0.8;
then, the total loss is:

L=0.5×0.3+1.0×0.5+1.5×0.8−0.15+0.5+1.2=1.85
3. dynamic optimization
3.1 online learning
trigger condition:
after every 100 detected frames, if the total loss L>1.5 L>1.5 L>1.5, online fine-tuning is activated;
optimization process:
a. freeze the backbone network: keep the YOLOv5s backbone feature extraction layers unchanged, and train only the newly added infrared detection head and the final fully connected layer;
b. gradient descent: update network weights using the Adam optimizer with a learning rate of 10-4;
c. stopping condition: terminate training when the total loss reduction over five consecutive batches is less than 0.1%.
3.2 dynamic weight adjustment:
3.2.1 illumination adaptation:
according to the average brightness V_{avg} of the current frame, dynamically adjust the classification loss weight:

$${λ}_{cls} = 0.5 + 0.3 \cdot tanh ( \frac{{V}_{avg} - 128}{50} )$$

thus:
daytime (V_{avg}=200): λ_{cls}=0.8 (enhances classification capability);
nighttime (V_{avg}=100): λ_{cls}=0.5 (balances classification and localization).
3.2.2 occlusion scenario optimization:
if detection fails continuously for three frames, the confidence loss weight is increased:

λ_{obj}=1.0+0.5·occlusion duration(s)
control module: the control module maps the geometric center position of the monochrome stick-shaped object to the screen coordinate system and executes a click operation in response to a single-click signal;
specifically, the control module supports protocol compatibility with external devices to enable cross-platform control of televisions, computers, or smart terminals;
during the implementation, the external device protocols include HDMI-CEC, USB HID, and Bluetooth interface.

The invention and the embodiments thereof are described hereinabove, and this description is not restrictive. What is shown in the drawings is only one of the embodiments of the invention, and the actual structure is not limited thereto. In summary, structural methods and embodiments similar to the technical solution without departing from the inventive purpose of the invention made by inspired ordinary technicians in the art without creative efforts shall all fall within the protection scope of the invention.

1. A cursor control system based on monochrome stick image recognition, comprising:
an image acquisition module, used for acquiring continuous video frames containing a monochrome stick-shaped object in real time through a camera;
a preprocessing module, which converts the video frames from the RGB color space to the HSV color space and establishes a monochrome hue threshold range model:
Hₘᵢₙ∈[35,77] Sₘᵢₙ≥50 Vₘᵢₙ≥50
wherein: H refers to the hue value, S refers to the saturation, V refers to the lightness value;
a target detection module, which performs noise reduction on the binary image through morphological operations, adopts Canny edge detection combined with contour analysis algorithm to extract monochrome stick-shaped object that meet the following geometric features:
length-width ratio>3:1 outline area>100 pixels circularity≤0.3
a coordinate mapping module, which converts the detected geometric center coordinates (x_{c}, y_{c}) of the monochrome stick-shaped object into the screen cursor coordinates (X, Y) through a bilinear interpolation algorithm:
$$X = \frac{{x}_{c} - {x}_{m i n}}{{x}_{m ax} - {x}_{m i n}} \times {W}_{screen}$$
$$Y = \frac{{y}_{ma x} - {y}_{c}}{{y}_{m ax} - {y}_{m i n}} \times {H}_{screen}$$
wherein, (xₘᵢₙ, yₘᵢₙ) and (xₘₐₓ, yₘₐₓ) refer to the boundary coordinates of the image acquisition area, W_{screen} and H_{screen} refer to the screen display resolutions;
an action recognition module, which determines the operation instruction by calculating the displacement vector modulus |Δ\vec{r}| and angular velocity ω of the monochrome stick-shaped object between consecutive frames:
$$\vert Δ \vec{r} \vert = \sqrt{{( {x}_{c , t} - {x}_{c , t - 1} )}^{2} + {( {y}_{c , t} - {y}_{c , t - 1} )}^{2}}$$
$$ω = arctan ( \frac{{y}_{c , t} - {y}_{c , t - 1}}{{x}_{c , t} - {x}_{c , t - 1}} )$$
when |Δ\vec{r}|>15 pixels and the w mutation exceeds 45 degree, a click event is triggered;
a control module: it maps the geometric center position of the monochrome stick-shaped object to the screen coordinate system, and responds to the click signal to perform the click operation.

2. The cursor control system based on monochrome stick image recognition according to claim 1, wherein the preprocessing module comprises an adaptive illumination compensation unit, which dynamically adjusts the V channel through a histogram equalization algorithm; the compensation coefficient is calculated as follows:
$${k}_{comp} = \frac{{V}_{target}}{{V}_{ang}} ( {V}_{avg} \geq 128 )$$
wherein, V_{target} refers to the target brightness value, taking the range of 180-220.

3. The cursor control system based on monochrome stick image recognition according to claim 1, wherein the coordinate mapping module integrates a three-dimensional space compensation algorithm; when the camera and the display screen are in a non-orthogonal layout, a perspective transformation matrix is introduced:
$$[ \begin{matrix}X \\ Y \\ 1\end{matrix} ] = [ \begin{matrix}{a}_{11} & {a}_{12} & {a}_{13} \\ {a}_{21} & {a}_{22} & {a}_{23} \\ {a}_{31} & {a}_{32} & 1\end{matrix} ] [ \begin{matrix}{x}_{c} \\ {y}_{c} \\ 1\end{matrix} ]$$
wherein, the matrix parameters are obtained in advance through Zhang Zhengyou calibration method.

4. The cursor control system based on monochrome stick image recognition according to claim 1, wherein it also comprises an anti-occlusion unit, when the monochrome stick-shaped object is temporarily occluded, the cursor position continuity is maintained based on a motion prediction model, and the prediction formula is: [symbol]
(t+1)=x_{c}(t)+vₓ(t)·Δt, [symbol] (t+1)=y_{c}(t)+v_{y}(t)·Δt
wherein, vₓ, v_{y} refer to the instantaneous velocity of the geometric center of the monochrome stick before occlusion.

5. The cursor control system based on monochrome stick image recognition according to claim 1, wherein the motion recognition module comprises a multi-user interaction unit; when multiple monochrome stick-shaped objects are detected, the control rights are allocated according to the following priority rules:
the target with the largest area has the highest priority;
the target that has just entered the field of view has temporary priority (lasts for 3 seconds);
the target with overlapping areas exceeding 50% activate competition mode, and those with faster displacement speeds gain control.

6. The cursor control system based on monochrome stick image recognition according to claim 1, wherein it also comprises an environment adaptation module, which continuously optimizes the detection parameters through a machine learning algorithm, wherein the algorithm adopts an improved YOLOv5 network structure, and the loss function is defined as:
L=λ_{cls}L_{cls}+λ_{obj}L_{obj}+λ_{box}L_{box}
wherein, λ_{cls}=0.5, λ_{obj}=1.0, λ_{box}=1.5.

7. The cursor control system based on monochrome stick image recognition according to claim 1, wherein the camera is a wide-angle lens with a field of view angle θ>120° and a frame rate f≥30 fps, which is suitable for cursor control in large space scenes.

8. The cursor control system based on monochrome stick image recognition according to claim 1, wherein a reflective mark or an infrared transmitter may be attached to an end of the monochrome stick-shaped object, which can be used in conjunction with a camera to achieve multi-modal positioning, thereby improving recognition robustness in complex lighting environments.

9. The cursor control system based on monochrome stick image recognition according to claim 1, wherein the control module supports protocol compatibility with external devices, thereby achieving cross-platform control of televisions, computers or smart terminals.

10. The cursor control system based on monochrome stick image recognition according to claim 9, wherein the protocols of the external device comprises HDMI-CEC, USB HID and Bluetooth interface.
